(19) United States
(12) Patent Application Publication
(10) Pub. No.: US 2006/0180449 A1
(43) Pub. Date: Aug. 17, 2006

(54) Switching mechanism for a fastening-bar closing device

(76) Inventor: Alexander Raisig, Hattingen (DE)

Correspondence Address: ST. ONGE STEWARD JOHNSTON & REENS, LLC, 986 BEDFORD STREET, STAMFORD, CT, 06905-5619, US

(21) Appl. No.: 11/048,482

(22) Filed: Feb. 1, 2005

(51) Int. Cl. H01H 17/00

(52) U.S. Cl. 200/331

(57) ABSTRACT

A switching mechanism for a fastening-bar closing device with a switch housing mounted with the rear, in particular, on a cuff or fold and with sections of two fastening bars extending into the housing and movably coupled with one another around a power transmitting means that switches by 180 degrees in such a way that a linear motion of one of the two bars in one direction propels the other bar in the opposite direction. Essential to the invention is that the power transmitting means includes a number of pusher elements that are grouped in two uninterrupted rows and positioned so that they can slide in a 180-degree channel of the switch housing resulting from a housing aperture, with a stud extending in the middle of the housing aperture that is of about the height of the pusher elements. The pusher elements are cylindrical bodies, which are retained in the channel by a cap that merely covers the peripheral area of the housing aperture. Sections of the two fastening bars extend through this gap.

### FIELD OF THE INVENTION

The invention relates to a switching mechanism for a fastening-bar closing device with a switch housing mounted toward the rear in particular, on a cuff or fold and with sections of two fastening bars extending into the housing and movably coupled with one another around a power transmitting means that switches by 180 degrees in such a way that a linear motion of one of the two bars in one direction propels the other bar in the opposite direction. The power transmitting means includes a number of pusher elements that are contiguous with one another and, grouped in two uninterrupted rows, are positioned so that they can slide in a 180-degree channel of the switch housing resulting from a housing aperture, with a stud extending in the middle of the housing aperture that is of about the height of the pusher elements.

A generically related operating mechanism is reported in GB 2337556. In this shoot bolt mechanism, two end sections of one fastening bar each, bent at an angle, engage in a guide track. The track also contains pusher elements in the form of ball bearings so that a 180-degree switching motion is performed.

Patent DE 1095709 describes a similar operating mechanism for fastening bars. Another switching mechanism is described in FR 2435586. Here too, pusher elements are provided in the form of ball bearings.

EP 0327264 reports a generically related operating mechanism in the form of a drive mechanism for a window closure. The window closure engages on one of the two fastening bar sections with a rack and pinion. The two fastening bar sections opposite one another are toothed. The power transmitting means in this case comprises a toothed belt, the teeth of which engage in the teeth apertures of the fastening bar sections.

It is the object of the invention to perfect a generic switching mechanism in such a user-friendly manner that the power transmitting is improved.

The object is achieved through the invention as detailed in the patent Claims.

Claim 1 provides essentially that the pusher elements are cylindrically rounded bodies which are retained in the track by a cap that overlaps only the marginal area of the housing aperture, and thus the gap between the cap and the wall of the housing aperture is large enough so that the sections of the two fastening bars can protrude there. The power transmitting means have a number of pusher elements that succeed one another without interruption. These elements are slidably arranged so that they can slide in a 180-degree channel of the switch housing. The power is transmitted by several power transmitting means, which are arranged slidably in the 180-degree channel of the switch housing, so that the switch housing also contributes to the power transmission. The power transmitting means are preferably positioned between contact members of the fastening bar sections. The contact members are formed by angled portions of the fastening bars that protrude into the 180-degree channel of the switch housing. The power transmitting means are configured as pusher elements contiguous with one another. As a result of this configuration the power is transmitted from the one fastening bar to the other fastening bar by a pressure exerted on the pusher elements so that these elements can be displaced along the 180-degree channel inside the switch housing. The pusher elements can be slid along the wall of a housing aperture that forms the 180-degree switching channel by the contact members, that is, by the angled ends of the fastening bars. For this purpose the housing aperture is configured as a ring groove. This ring groove has two sections that extend parallel to one another in the direction of the displacement direction of the fastening bars. The contact members move in these sections when the fastening bars are displaced. The two sections extending in straight lines are connected to one another by arched sections that form the narrow side walls of the housing. The pusher elements slide along the arched sections when power is exerted on them. In an advantageous embodiment, the pusher elements are capable of rolling along the housing walls. In such case they are configured as rotary bodies. The pusher elements can also, however, glide along the housing aperture wall. In that case it is sufficient if the pusher elements are configured as cylindrically rounded bodies or at least as cylindrical bodies. The pusher elements can be arranged separately and contiguously to one another in the housing aperture. In that case one pusher element lies behind the other. The ring groove has in its center a stud extending in the direction of the housing extension. This stud is of the approximate height of the pusher elements. This has the advantage that a cap set on the stud holds the pusher elements in the channel. The cap is thus not required to extend over the entire surface of the housing aperture. It is sufficient for the cap to cover adequately large sections of the pusher elements. Vacant space is left between the housing inside wall and the edge of the cap. The contact member of the fastening bar can protrude into this vacant space. Because a total of two series of pusher elements are provided, lying contiguous to one another with only minor free play in between, forward and receding motion of one fastening bar is transmitted to the other. One of the two fastening bars can have at its end a bolt head that can engage in a counterlocking part of a door frame or the like. The other fastening bar can be driven by a lock or the like.

The object of the invention is depicted hereafter by means of an illustrated embodiment.

### BRIEF DESCRIPTION OF THE DRAWINGS

FIG. 1 shows a profile view of the completely installed fastening-bar switching mechanism.

FIG. 2 shows an overhead view of the complete fastening-bar switching mechanism, with the switch housing shown partially opened for clarity.

FIG. 3 shows a cross-section of the line IV-IV of FIG. 2.

FIG. 4 shows an opened sectional view of FIG. 2 according to the section V-V in FIG. 3.

FIG. 5 shows the valve-like side view of FIG. 2, with the switch housing shown opened for clarity.

FIG. 6 shows the section along the line VI-VI in FIG. 5.

FIG. 7 shows the opened view of the section VII-VII in FIG. 6.

FIG. 8 shows an isometric view of the dismantled fastening-bar switching mechanism.

FIG. 9 shows the fastening-bar switching mechanism in basic position, with the switch housing opened for clarity.

FIG. 10 shows the fastening-bar switching mechanism half extended in activated condition, with the switch housing opened for clarity.

FIG. 11 shows the fastening-bar switching mechanism in the end position after activation, with the switch housing opened for clarity.

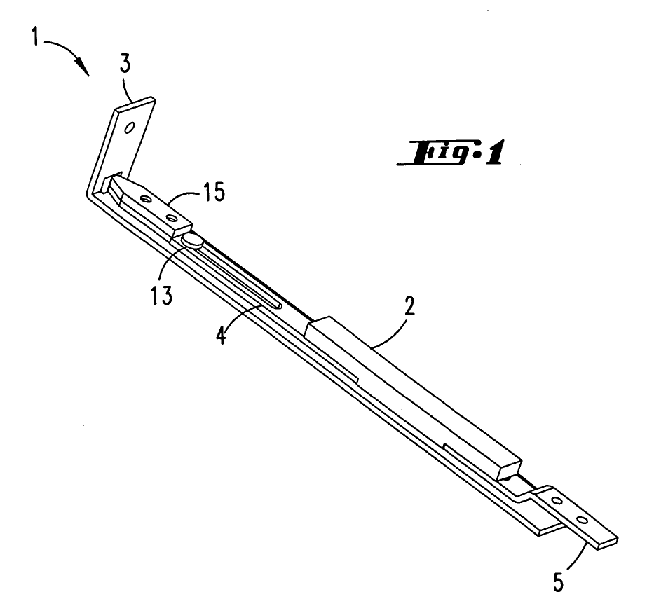

The embodiment is an angled-bolt mechanism. The cuff or fold designated as number 3, angled in shape, can be installed in the corner area of a door leaf (not shown). In back of the cuff or fold 3 is a bolt bar 4 with a trapezoidal-shaped bolt head 15 on the end, which head can emerge through an opening in the angle of the cuff. By means of a mandrel 13, which grips through a longitudinal hole in the bolt bar 4, the bolt bar 4 is held slidably on the cuff. The end of the bolt bar 4 toward the bolt 15 protrudes into a switch housing 2. One end of a fastening bar also protrudes into the switch housing 2 and can be displaced by a lock (not shown). To displace the bolt 15 through the window in the cuff 3, the fastening bar 5 must be displaced in the direction counter to the bolt bar 4.

The reverse motion takes place within the switch housing 2. The switch housing 2 consists of a power cast body, which has on its interior a ring-shaped closed aperture, which is closed by the cuff 3.

The ring-shaped aperture 7 has an outer wall 8, which forms two wall members running parallel to one another, which are connected to one another at a 180-degree angle. The inner wall 9 of the aperture is formed by a stud. The floor of the aperture forms a running track 10. The transition of the floor to the two walls 8, 9 of the aperture 7 is provided by a narrow groove 11.

Inside the ring-shaped closed aperture 7, cylindrical pusher elements 6 lie closely contiguous to one another. Diametrically opposite, angled ends of the fastening bars 4, 5 extend between pusher elements 6. These angled ends form contact members 14. In the area of the contact members 14 the fastening bars form rounded diagonals 18. This prevents the ends of the fastening bars collide with one another.

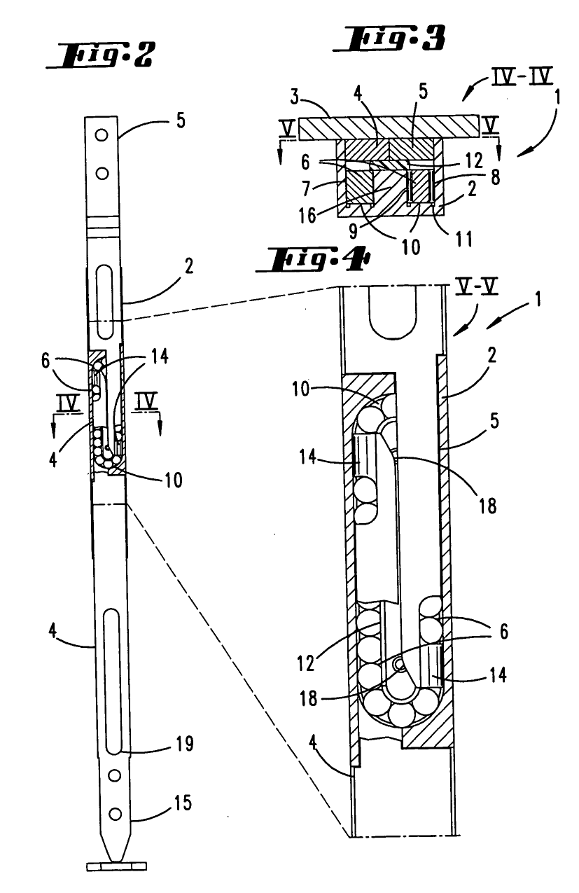

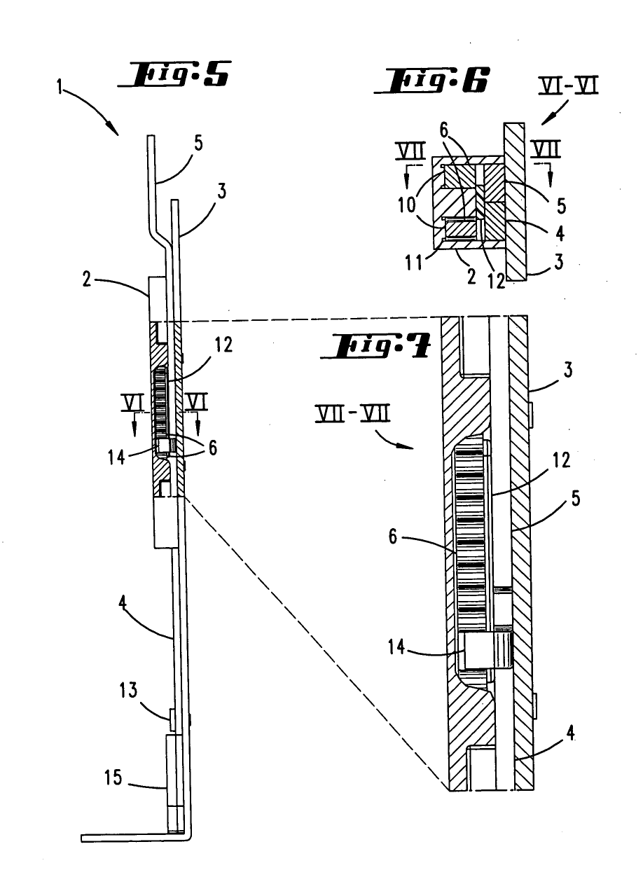

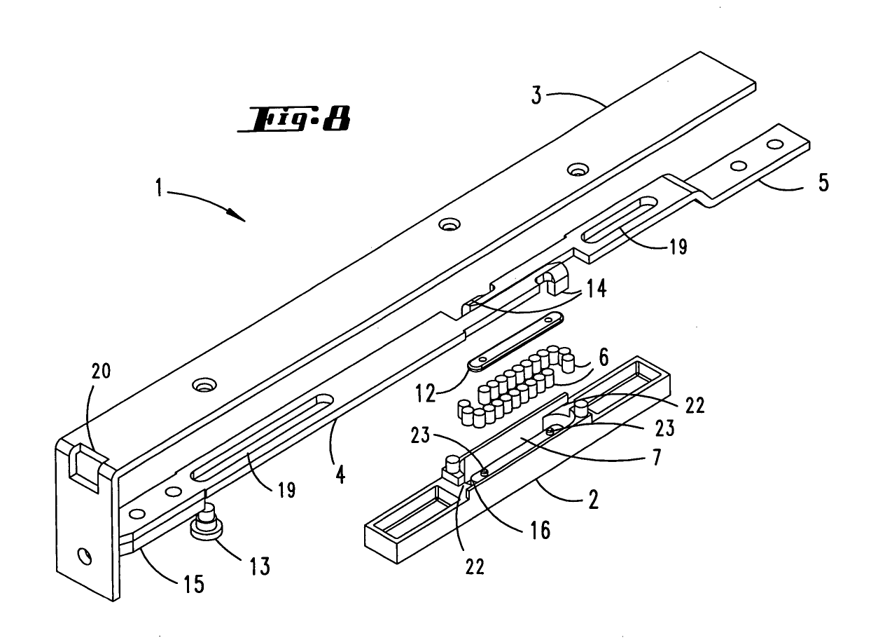

As can be seen in particular from FIG. 3, the stud 16 is provided with a cap 12. The peripheral area of the cap 12 extends over the aperture 7. It is secured to the stud 16 by retaining bolts 23.

The contact members 14 are seated on tapered ends of the fastening bars 4, 5. These tapered portions extend through apertures 22 of the housing 2. The tapered ends lie between the cuff 3 and the cap 12. The border of the cap thus covers the front sides of the pusher elements 6. The angled ends 14 of the fastening bars 4,5 extend beyond the cap into a space between the pusher elements 6. The gap between the cap 12 and the wall 8 is sized large enough so that the angled end 14 can extend through it, but on the other hand small enough that the pusher elements 6 cannot extend through this gap but instead are led between the edge of the cap 12 and the running track 10.

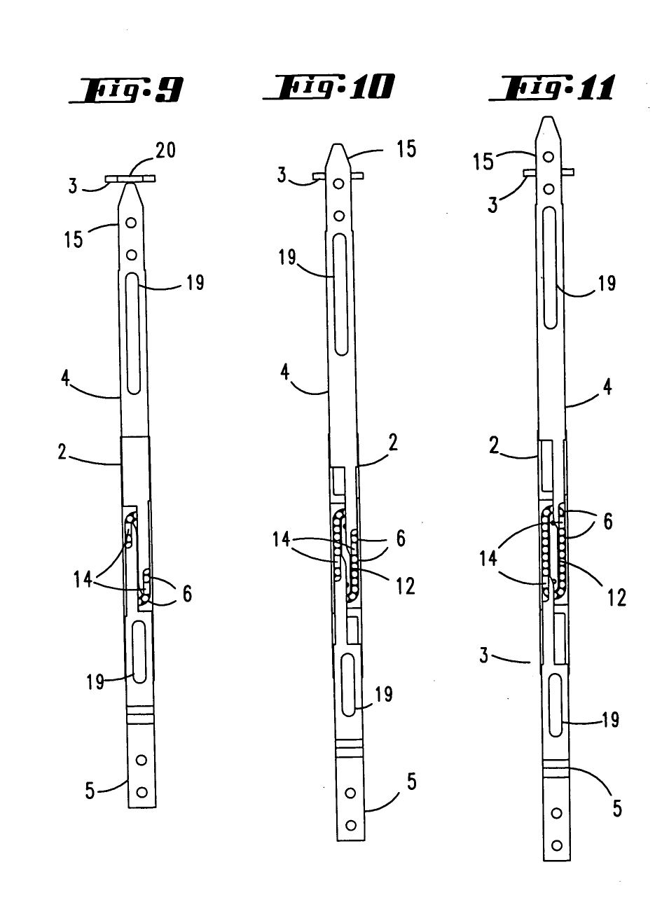

The device functions as follows. A fastening-bar lock, not shown, displaces the fastening bar 5 in the direction away from the switch housing 2. Starting from an operating position as shown in FIG. 9, the contact member 14 slides the fastening bar 5 [and] the cylindrical pusher element 6 along the running track 10 around the arched sections of the aperture 7. The final pushing element 6 in the series comes in contact with the contact member 14 of the fastening bar 4 that has the bolt head 15. The fastening bar 4 is displaced, consequently, in opposite direction to the fastening bar 5 by way of the intermediate position shown in FIG. 10, outward as far as the locking position shown in FIG. 11.

If the lock is activated in an operating position as shown in FIG. 11, the fastening bar 5 is displaced onto the switch housing 2. Proceeding in that manner, the contact member 14 of the fastening bar 5 contacts the first of the pusher elements 6 arranged in a row one behind the other and pushes the remaining elements by way of the running track 10 inside the aperture 7 around the 180-degree channel, so that the front-most pusher element 6 contacts the contact member 14 of the fastening bar 4 that bears the bolt head 15. By means of the intermediate position shown in FIG. 10, therefore, the unlocking position shown in FIG. 9 is reached.

All described characteristics are (of themselves) essential to the invention. The publication of this application thus includes also the described content of the related/enclosed priority documents (portion of the preliminary application), for the purpose of including characteristics of these documents in the claims of the present application.

1. A switching mechanism for a fastening-bar closing device with a switch housing mounted with the rear, in particular, on a cuff or fold and with sections of two fastening bars extending into the housing and movably coupled with one another around a power transmitting means that switches by 180 degrees in such a way that a linear motion of one of the two bars in one direction propels the other bar in the opposite direction. The power transmitting means includes a number of pusher elements that are contiguous with one another and, grouped in two uninterrupted rows, are positioned so that they can slide in a 180-degree channel of the switch housing resulting from a housing aperture, with a stud extending in the middle of the housing aperture that is of about the height of the pusher elements, distinguished in that the pusher elements are rounded cylindrical bodies, which are retained in the channel by a cap that merely covers the peripheral area of the housing aperture, and that the gap between the cap and the wall of the housing aperture is large enough so that the sections of the two fastening bars can extend into it.

2. A switching mechanism according to claim 1, distinguished in that the housing aperture constitutes a ring-shaped groove with two parallel sections extending in the displacement direction of the fastening bars and two arched sections on the narrow sides of the housing aperture.

3. A switching mechanism according to claim 1, distinguished in that the pusher elements are separate and inserted in contiguous position in the housing aperture.

4. A switching mechanism according to claim 1, distinguished in that the contact members are angled ends of the fastening-bar sections, which extend into the housing aperture.
